(19) United States
(12) Patent Application Publication
(10) Pub. No.: US 2016/0208915 A1
(43) Pub. Date: Jul. 21, 2016

(54) MECHANICAL GEAR SHIFT WITH AUTOMATED CLUTCHING

(71) Applicant: Deere & Company, Moline, IL (US)

(72) Inventors: John J. Gallen, Waterloo, IA (US); Timothy J. Annesley, Waterloo, IA (US); Mark A. Herman, La Porte City, IA (US); John A. Fischer, Cedar Falls, IA (US); Adam Faucher, Cedar Falls, IA (US)

(21) Appl. No.: 14/601,292

(22) Filed: Jan. 21, 2015

(51) Int. Cl. F16H 61/682; F16D 48/06; F16H 59/40; F16H 59/68; F16H 59/70

(52) U.S. Cl. CPC F16H 61/682; F16H 59/68; F16H 59/70; F16H 59/40; F16D 48/06; F16H 2059/6807; F16D 2500/10406

(57) ABSTRACT

In accordance with an example embodiment, a transmission shifting apparatus may include a transmission having a plurality of gears and a clutch positioned between a power source and the transmission. A shift lever may operably connect to the transmission, such that movement of the shift lever causes the transmission to shift gears. A shift sensor may detect when the shift lever receives an operator input in a manner to generate a gear shift. A shift controller may selectively disengage the clutch when the shift sensor detects the operator input applied to the shift lever, and selectively engage the clutch when the shift controller determines the shift is complete.

### CROSS-REFERENCE TO RELATED APPLICATIONS

This application relates to U.S. application Ser. No. 13/719,413, titled MANUAL SYNCHRONIZED GEAR SHIFT ASSIST, filed Dec. 19, 2012, which is hereby incorporated by reference in its entirety.

### FIELD OF THE DISCLOSURE

The present disclosure relates generally to transmissions.

### BACKGROUND

Transmissions can be selectively coupled to a power source with a clutch. When the clutch is engaged, the transmission is coupled to the power source. When the clutch is disengaged, the transmission is uncoupled from the power source allowing the manual transmission to change gears. In order to shift a manual transmission from one gear to another, the clutch, or clutch pedal, is manually disengaged allowing a shift. After the gear shift is complete, the clutch, or clutch pedal, is manually reengaged which couples the power source with the transmission.

### SUMMARY

This summary is provided to introduce a selection of concepts that are further described below in the detailed description and accompanying drawings. This summary is not intended to identify key or essential features of the appended claims, nor is it intended to be used as an aid in determining the scope of the appended claims.

According to an aspect of the present disclosure, a transmission shifting apparatus may include a transmission having a plurality of gears and a clutch positioned between a power source and the transmission. The clutch may couple the power source to the transmission in an engaged position and uncouple the power source from the transmission in a disengaged position. A shift lever may operably connect to the transmission, such that movement of the shift lever causes the transmission to shift gears. A shift sensor may detect when the shift lever receives an operator input in a manner to generate a gear shift. A shift controller may selectively disengage the clutch when the shift sensor detects the operator input is applied to the shift lever, and selectively engage the clutch when the shift controller determines the shift is complete.

A method of shifting a transmission in a vehicle may include automatically disengaging a clutch when a shift sensor detects a shift lever has received an operator input in a manner to generate a gear shift in the transmission; and automatically engaging the clutch when the shift controller determines the shift is complete. The disengaged clutch may uncouple the transmission from a power source, and the engaged clutch may couple the transmission with the power source.

These and other features will become apparent from the following detailed description and accompanying drawings, wherein various features are shown and described by way of illustration. The present disclosure is capable of other and different configurations and its several details are capable of modification in various other respects, all without departing from the scope of the present disclosure. Accordingly, the detailed description and accompanying drawings are to be regarded as illustrative in nature and not as restrictive or limiting.

### BRIEF DESCRIPTION OF THE DRAWINGS

The detailed description of the drawings refers to the accompanying figures in which:

FIG. 1 is a perspective view of a work machine, according to one embodiment;

FIG. 2 is a perspective view of a transmission and operator shift lever, according to one embodiment;

FIG. 3 is a perspective view of an interior portion of a transmission, according to one embodiment;

FIG. 4 is a perspective view of an interior portion of an operator compartment, according to one embodiment;

FIG. 5 is a perspective view of an interior portion of an operator compartment, according to one embodiment;

FIG. 6 is a schematic diagram of a shift control unit, or shift controller, according to one embodiment;

FIG. 7 is a schematic diagram of an implementation of a shift control unit, or shift controller, in a work machine, according to one embodiment;

FIG. 8A is a diagram of a shift pattern for a shift lever, according to one embodiment;

FIG. 8B is a diagram of a shift pattern for a shift lever, according to one embodiment;

FIG. 8C is a diagram of a shift pattern for a shift lever, according to one embodiment;

FIG. 8D is a diagram of a shift pattern for a shift lever, according to one embodiment;

FIG. 9 is a flow diagram illustrating a method of shifting gears in a transmission, according to one embodiment;

FIG. 10 is a flow diagram illustrating a method of shifting gears in a transmission, according to one embodiment; and

FIG. 11 is a flow diagram illustrating a method of shifting gears in a transmission, according to one embodiment.

Like reference numerals are used to indicate like elements throughout the several figures.

### DETAILED DESCRIPTION

The embodiments disclosed in the above drawings and the following detailed description are not intended to be exhaustive or to limit the disclosure to these embodiments. Rather, there are several variations and modifications which may be made without departing from the scope of the present disclosure.

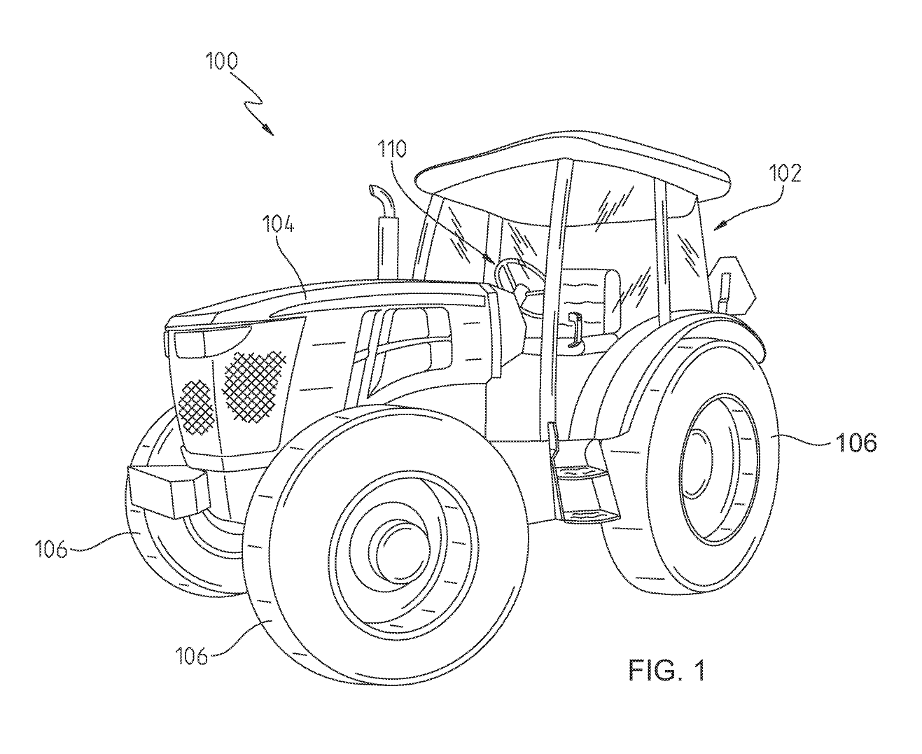

FIG. 1 illustrates a work machine 100, such as a tractor, for example. Although a tractor is shown in FIG. 1, the present disclosure is not limited to tractors, but also applies to other powered or motorized vehicles. The machine 100 may include an operator compartment or cab 102 where a machine operator may control the operation of the machine 100. The machine 100 may include a frame 104 to which a front and rear axle (not shown) are operably connected. The front and rear axles may each include one or more ground engaging apparatus 106 (e.g., wheels) operable connected. The machine 100 may include a power source, a transmission, and a clutch operably coupling the power source and the transmission.

The transmission may be operably coupled to the ground engaging apparatus 106, providing locomotion for the machine 100. The machine 100 may include one or more operator controls 110, such as a steering wheel, shift lever, shift buttons, dashboard display, etc., which may be included in the cab 102. One or more of these operator controls 110 may be operably coupled to the transmission for controlling an operation of the machine 100, for example a shift lever for controlling the forward or reverse gear or range, as described in more detail below.

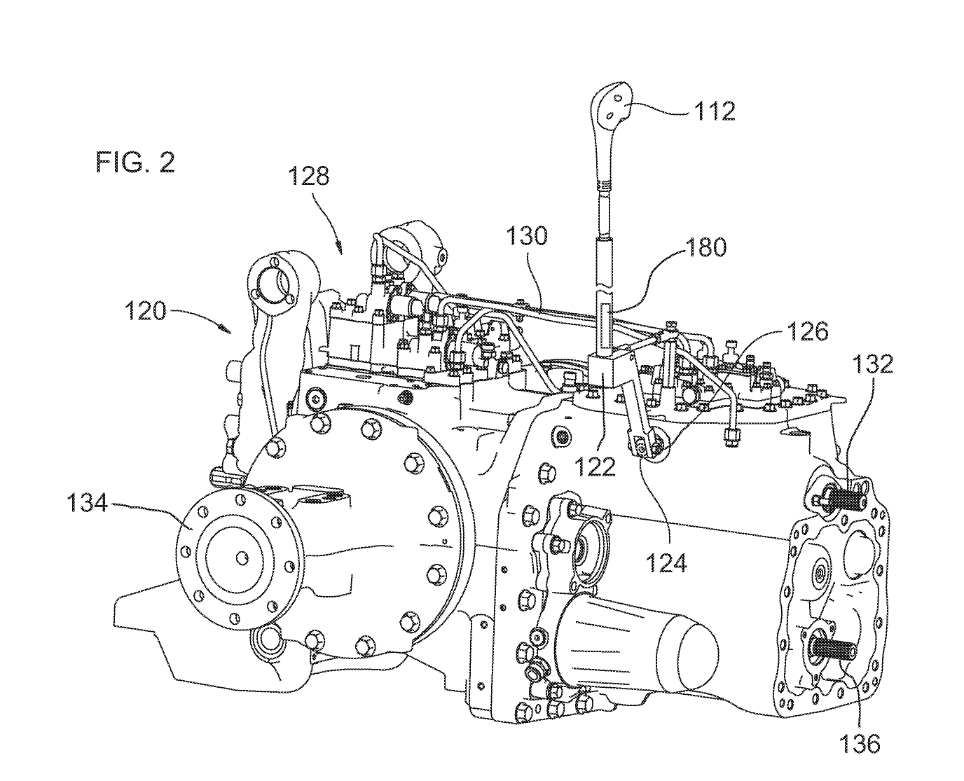

FIG. 2 illustrates a transmission 120, which may be located beneath the cab 102 of the machine 100 shown in FIG. 1, for example. One of the operator controls 110, shown in FIG. 1, may be a shift lever 112. The shift lever 112 may be located in the cab 102, shown in FIG. 1, so that a machine operator can control the shifting of a transmission 120. The shift lever 112 may be mechanically connected to the transmission 120 via a mechanical linkage 122. The mechanical linkage 122 may be connected to a cross shaft 124 via a fastener 126, such as a pin, for example. In this manner, the cross shaft 124 can be rotationally and linearly actuated in response to a movement of the shift lever 112.

The transmission 120 may include a control manifold 128 for providing or communicating fluid to different portions of the transmission 120. The control manifold 128 may be integrally coupled with the transmission 120. The transmission 120 may include one or more internal flow paths for directing and transporting fluid within the transmission 120. The transmission 120 may include a fluid supply line 130 fluidly coupled to the control manifold 128 at one end and to the one or more internal flow paths with the transmission 120 at the other end. The transmission 120 may include an input shaft 132 for receiving power from one or power sources. The transmission 120 may include an output 134 for one or more rear axles of the work machine. The transmission 120 may include an output 136 for one or more front axles of the work machine.

The shift lever 112 may include a shift sensor 180, which detects when a shift is initiated. The shift sensor 180 may detect when an operator input is applied to the shift lever 112. A machine operator may apply a force or input to the shift lever 112 in order to change or shift gears within the transmission 120. The shift sensor 180 may sense or detect the magnitude of the operator input applied to the shift lever 112, the direction of the operator input applied to the shift lever 112, or both. The shift sensor 180 may detect when the operator input is removed from the shift lever 112. The shift sensor 180 may detect when the shift is complete, or when the shift lever 112 is in the desired gear or range.

The shift sensor 180 may detect when the shift lever 112 is receiving an operator input. The shift sensor 180 may detect whether the operator input is a shifting input or a non-shifting input. A shifting input, for example, includes an operator input applied in a manner and direction that would generate a gear shift or change. A non-shifting input, for example, includes an operator input applied in a manner or direction that would not generate a gear shift or change. The shift sensor 180 can be any type of sensor capable of detecting an operator input and a direction including, but not limited to, inductive sensors or strain gauges. The shift sensor 180 can be positioned anywhere on the shift lever 112, the mechanical linkage 122, or other shifting or transmission components.

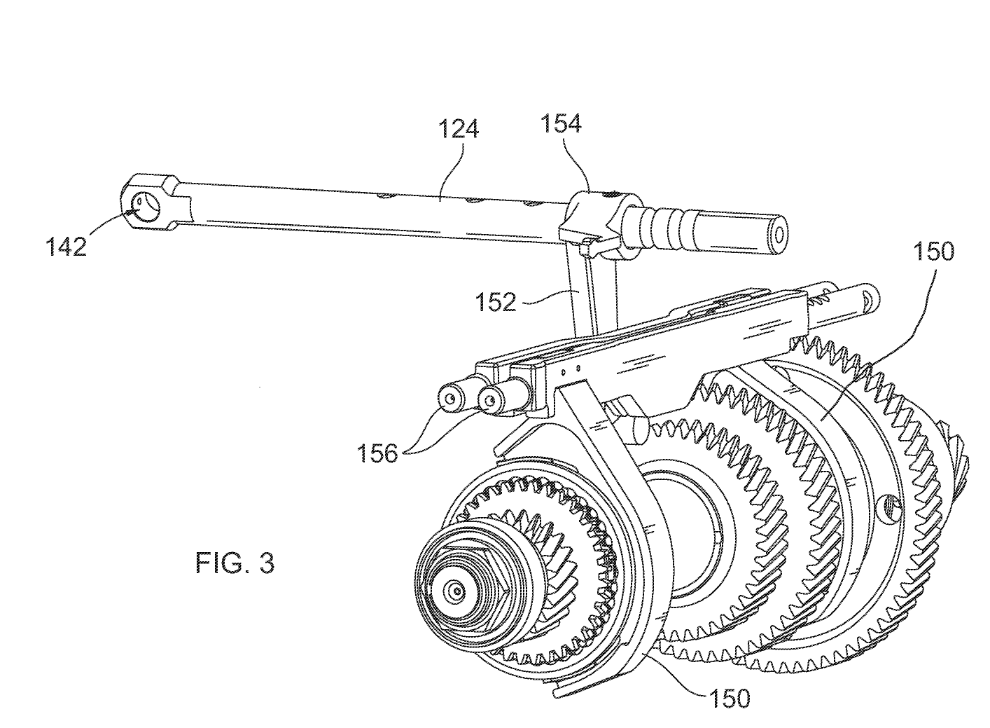

FIG. 3 illustrates an internal or interior portion of the transmission 120, according to one embodiment. The cross shaft 124 may include an opening 142 for receiving the fastener 126, shown in FIG. 2. The cross shaft 124 may operably connect to one or more synchronizers 150, which shift between the gears or ranges within the transmission 120. A range arm 152 may fixedly attach to the cross shaft 124 with a collar 154 at one end to and operable connect to the one or more shift rails 156 at the other end. The number of shift rails 156 depends on the number of gears or ranges into which the transmission 120 can shift. In some embodiments, each synchronizer 150 attaches to a shift rail 156, such that movement of one shift rail 156 causes movement of one synchronizer 150. When shifting out of a gear or range or shifting into another gear or range, the cross shaft 124 can slide axially or rotationally in response to movement of the shift lever 112 and mechanical linkage 122 such the range arm 152 engages one of the shift rails 156 moving one of the synchronizers 150.

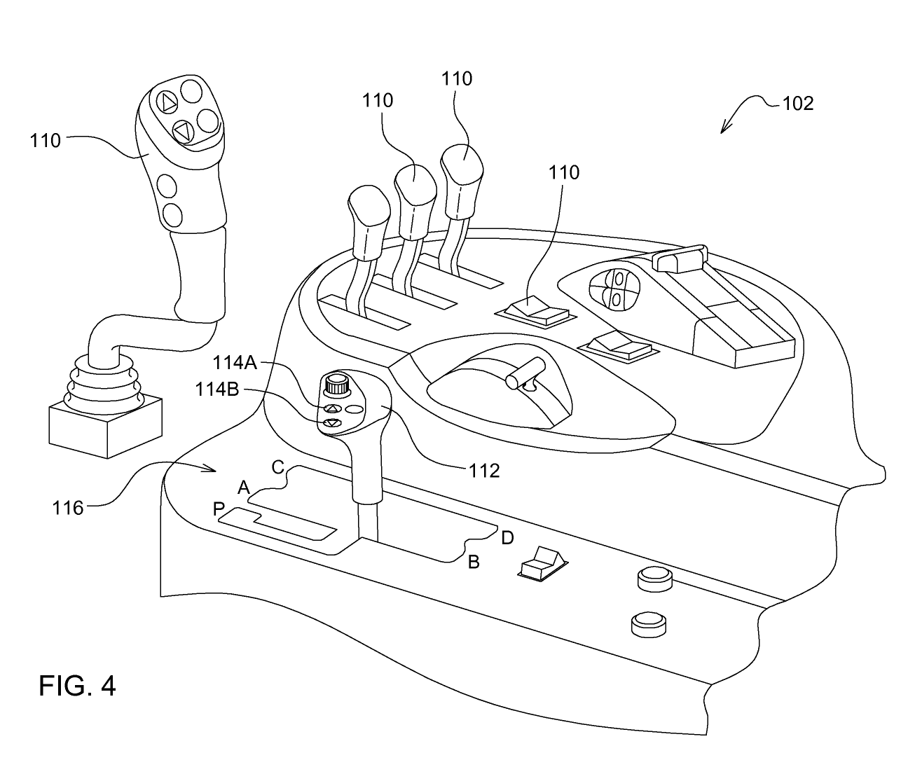

FIG. 4 illustrates an interior of a cab 102, according to some embodiments. One or more operator controls 110, including a shift lever 112, may be included in the cab 102. The shift lever 112 may control the shifting or changing of gears within a transmission, including, but not limited to, shifting from one forward gear to another, from a forward gear to a reverse gear, or vice versa, from a forward or reverse gear to neutral, or vice versa. The transmission may have multiple ranges gear selections and multiple speed gear selections within each range gear selection. The shift lever 112 may control one or more of the range gear selection and the speed gear selection. The shift lever 112 may move into one of the range positions in the shift pattern 116 (e.g., an H-pattern), to select the respective range gear A, B, C, and D, or into park P, as shown.

The shift lever 112 may include one or more speed shift controls 114. The shift lever 112 may include an up-shift control 114A and a down-shift control 114B. Within each range selection, each successive speed selection can be accessed or activated by using the one or more speed shift controls 114. For example, a machine operator may use the up-shift control 114A to increase the speed selection from a first speed to a second speed within a first range. In addition, the machine operator may use the down-shift control 114B to decrease the speed selection from a fourth speed to a third speed within a third range.

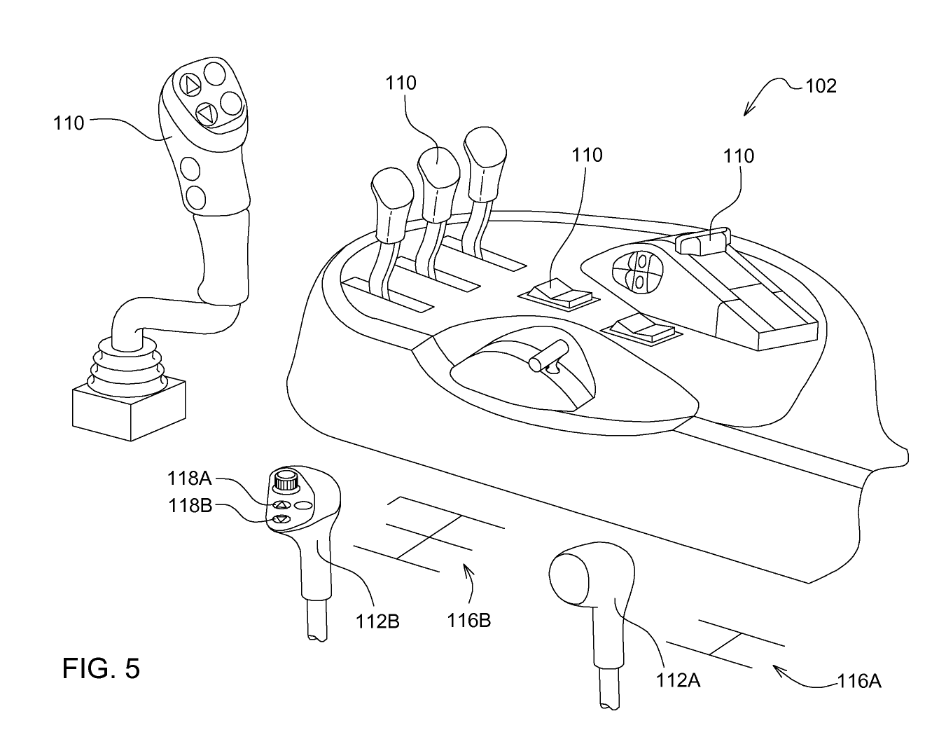

FIG. 5 illustrates an interior of a cab 102, according to some embodiments. One or more operator controls 110, including one or more shift levers 112, may be included in the cab 102. A range shift lever 112A and a speed shift lever 112B may be included in the cab 102. The range shift lever 112A and the speed shift lever 112B may control the shifting of gears within a transmission. The transmission may have multiple ranges gear selections, multiple speed gear selections within each range gear selection, and a high/low gear selection within each speed selection. The range shift lever 112A may control the range gear selection of the transmission. The speed shift lever 112B may control the speed gear selection of the transmission.

The range shift lever 112A can move into one of the range positions in the shift pattern 116A, (e.g., an H-pattern). The speed shift lever 112B can move into one of the speed positions in the shift pattern 116B, or into park. The speed shift lever 112B may control the high/low gear selection of the transmission. The speed shift lever 112B may include one or more high/low gear shift controls 118. The speed shift lever 112B may include a high gear shift control 118A and a low gear shift control 118B. Within each speed selection, the high or low gear selection can be accessed or activated by using the one or more high/low gear shift controls 118. For example, a machine operator may use the high/low gear shift control 118 to access a high gear in a first speed; or, the machine operator may use the high/low gear shift control 118 to access a low gear in a second speed.

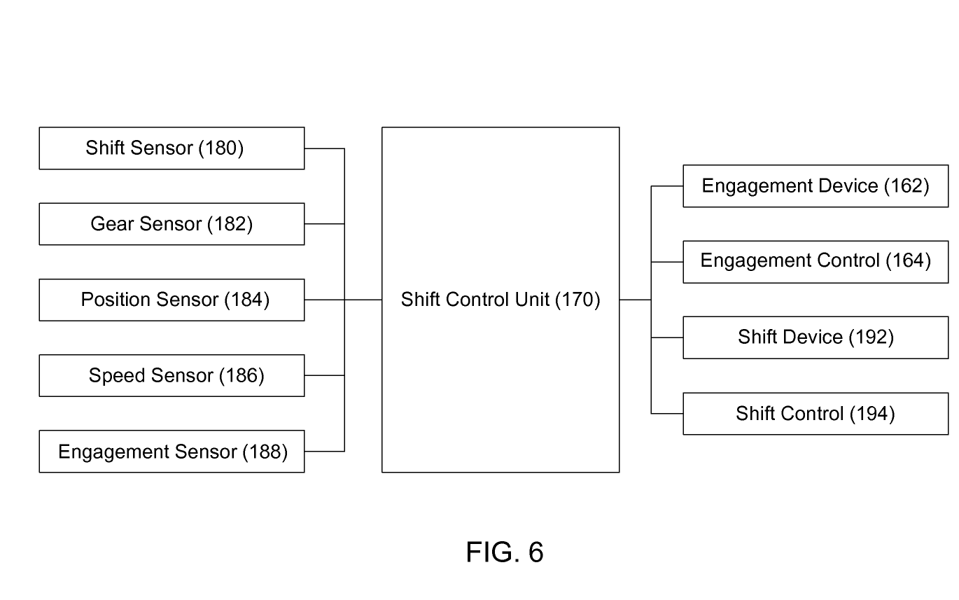

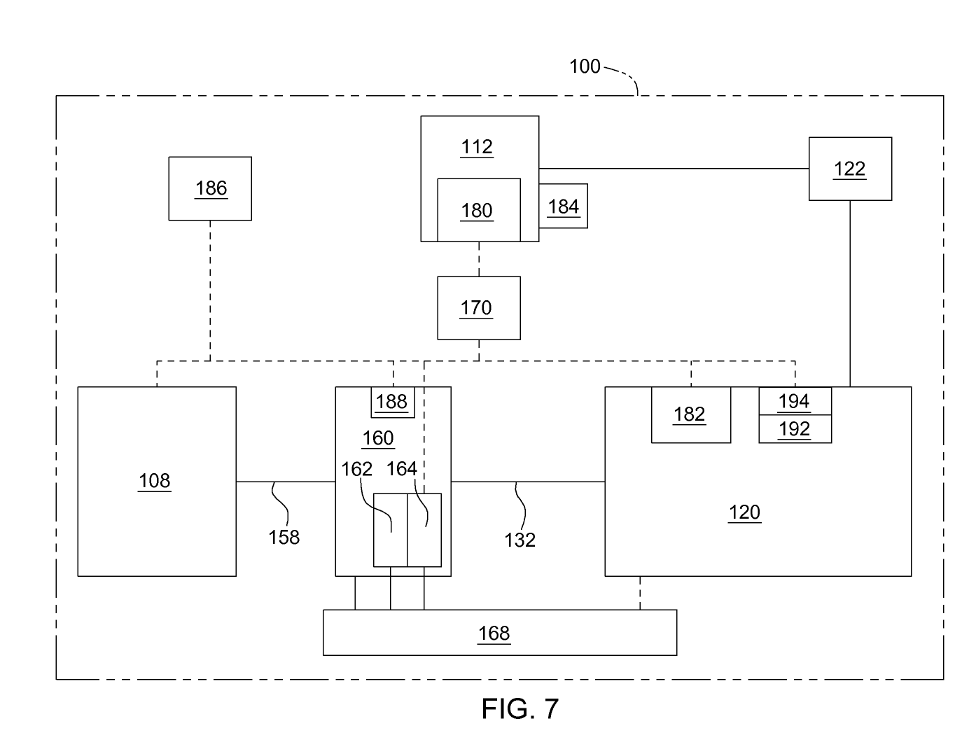

FIG. 6 illustrates a schematic diagram of a shift control unit, or shift controller, 170, according to one embodiment. FIG. 7 illustrates a schematic diagram of an implementation of a shift controller 170 in a work machine 100, according to one embodiment. The following description may refer to the embodiment in FIG. 6, the embodiment in FIG. 7, or both. The work machine 100 may include a power source 108, a transmission 120, and a clutch 160 operably coupling the power source 108 to the transmission 120. The power source 108, such as an internal combustion engine, an electric motor, or a combination, may include an output shaft 158 operably connected to the clutch 160. The transmission 120 may include an input shaft 132 operably connected to the clutch 160. When the clutch 160 is engaged, the clutch 160 couples the power source 108 to the transmission 120, and when the clutch is disengaged, the clutch 160 uncouples the power source 108 from the transmission 120. The clutch 160 can be any type of clutch, including but not limited to, a wet clutch or wet traction clutch. The work machine 100 may include a shift lever 112 and a mechanically linkage 122 coupling the shift lever 112 to the transmission 120, as discussed above.

The clutch 160 may be engaged and disengaged by an engagement mechanism 162, such as a mechanical actuator, a pneumatic actuator or cylinder, a hydraulic actuator or cylinder, an electro-mechanical actuator, or a linear motor, for example. When the engagement mechanism 162 moves in a first direction, the clutch 160 is engaged, and when the engagement mechanism 162 moves in a second direction, the clutch 160 is disengaged. An engagement control 164, such as a switch or valve, may direct the engagement mechanism 162 to move in either the first or second directions. For example, the engagement control 164 (e.g., an electro-hydraulic valve) may direct a fluid to a first side of the engagement mechanism 162 (e.g., a hydraulic cylinder) to move the engagement mechanism 162 in the first direction and engage the clutch 160, or to a second side of the engagement mechanism 162 to move the engagement mechanism 162 in the second direction and disengage the clutch 160. One or more hydraulic sumps 168 may be fluidly connected (e.g., hydraulic hoses or lines) and provide hydraulic fluid to the clutch 160, the engagement mechanism 162, the engagement control 164, and the transmission 120. Each device may have its own hydraulic sump 168 or it may share a hydraulic sump 168 with one or more of the other devices.

The shift control unit, or shift controller, 170 may include one or more microprocessor-based electronic control units or controllers. The shift controller 170 can be a programmable logic controller, also known as a PLC or programmable controller. The shift controller 170 may connect to a vehicle or tractor electronic control system through a data bus, such as a CAN bus, or the shift controller 170 could be a part of the vehicle or tractor electronic control system. The shift controller 170 may be in communication with one or more sensors including, but not limited to: a shift sensor 180, an engagement sensor 188, a gear sensor 182, a position sensor 184, and a speed sensor 186. The shift controller 170 may be in communication with one or more actuators or actuator controls including, but not limited to, an engagement device 162, an engagement control 164, a shift device 192, or a shift control 194.

The shift sensor 180 may be positioned on the shift lever 112 and detect when an operator input is applied to the shift lever 112, as described above. The engagement sensor 188 may be positioned on or near the clutch 160, the engagement mechanism 162, or the engagement control 164. The engagement sensor 188 detects whether the clutch 160 is engaged or disengaged. The engagement sensor 188 may be a position sensor which detects the position of the clutch 160, engagement mechanism 162, or engagement control 164; a pressure sensor which detects the fluid pressure in the clutch 160, engagement mechanism 162, or engagement control 164; or an electrical sensor which detects the electrical state in the clutch 160, engagement mechanism 162, or engagement control 164.

The gear sensor 182 may be positioned on or in the transmission 120 and detect which gear the transmission 120 is in including whether the transmission is in a neutral condition. The gear sensor 182 may detect the current gear by comparing the speeds of the relative transmission shafts. The gear sensor 182 may include one or more speed or rotation sensors to measure the speeds of the transmission shafts. The position sensor 184 may be positioned on the shift lever 112 or the mechanical linkage 122 and detect the position of the shift lever 112 including which gear the shift lever 112 is positioned in or whether the shift lever 112 is in the neutral position. The position sensor 184 may include one or more ball switches. The speed sensor 186 may be positioned near an output of the transmission 120 or an axle or wheel to detect whether the work machine 100 is moving and the speed and direction (i.e., forward or reverse). The speed sensor 186 may detect the speed and direction of an output of the transmission 120 or an axle or wheel and then determine or calculate the speed and direction of the work vehicle 100.

The shift controller 170 may be in electrical communication with one or more of the sensors and may use the electrical communication or signals received from one or more of the sensors to determine whether to engage or disengage the clutch 160. The shift controller 170 may determine whether to automatically engage or automatically disengage the clutch 160 based upon the input received from one or more sensors. The shift controller 170 may determine to disengage the clutch 160 when a shift is initiated. The shift controller 170 may determine that a shift is initiated when the shift sensor 180 detects an operator input applied to the shift lever 112 in manner to generate a gear shift in the transmission 120. The shift controller 170 may determine to engage the clutch when the shift is complete. The shift controller 170 may determine that the shift is complete when the shift sensor 180 detects that the operator input has been removed from the shift lever 112. The shift controller 170 may determine that the shift is complete when the transmission is in a different gear than when the shift started. The shift controller 170 may determine that the shift is complete when the transmission is in the same gear as when the shift started and the shift sensor 180 detects that the operator input has been removed from the shift lever 112. The shift controller 170 may determine to maintain the clutch in a disengaged condition if the shift does not complete or remains incomplete. The shift controller 170 may determine that the shift has not completed when the transmission remains in a neutral condition for specific or certain length of time and the shift sensor 180 detects that the operator input has been removed from the shift lever 112.

When the shift controller 170 determines the clutch 160 should be engaged, the shift controller 170 sends communication to the engagement control 164 to engage the clutch 160. The engagement control 164 may direct the engagement mechanism 162 to move in a first direction to engage the clutch 160. Alternatively, the shift controller 170 may directly control the engagement mechanism 162 to move in a first direction to engage the clutch 160. When the shift controller 170 determines the clutch 160 should be disengaged, the shift controller 170 sends communication the engagement control 164 to disengage the clutch 160. The engagement control 164 may direct the engagement mechanism 162 to move in a second direction to disengage the clutch 160. Alternatively, the shift controller 170 may directly control the engagement mechanism 162 to move in a second direction to disengage the clutch 160. In some embodiments, this automated clutching removes the need for the machine operator to manually disengage a clutch, or clutch pedal, before commencing the shift and manually engage the clutch, or clutch pedal, after the shift is complete.

The transmission 120 may include a shift mechanism 192 and a shift control 194. The shift mechanism 192 may utilize any mechanical, hydraulic, pneumatic, or electrical components to shift gears or ranges within the transmission 120 including, but not limited to, a mechanical actuator, a pneumatic actuator or cylinder, a hydraulic actuator or cylinder, an electro-mechanical actuator, or a linear motor. The shift control 194, such as a switch or valve, may direct the shift mechanism 192 to shift gears or ranges within the transmission 120. The shift controller 170 may use communication received from one or more of the sensors previously discussed to determine whether to shift gears within the transmission and into which gear to shift. When the shift controller 170 determines to shift gears, the shift controller 170 sends communication to the shift mechanism 192, or to the shift control 194, directing the shift mechanism 192 change gears within the transmission. The shift mechanism 192 then changes gears based at least partially upon the communication from the shift controller 170, the shift control 194, or both.

In some embodiments, the mechanical linkage 122 is used, and the shift mechanism 192 and shift control 194 are optionally excluded. In other embodiments, the shift mechanism 192 is used in place of the mechanical linkage 122. Minimal or little effort is required to move the shift lever 112 when shifting gears because the mechanical linkage 122 is replaced with the shift mechanism 192, which provides the effort to shift. In still other embodiments, the shift mechanism 192 and shift control 194 may be used in combination with the mechanical linkage 122. In these embodiments, a reduced effort is required to move the mechanical linkage 122 due to the assistance provided by the shift mechanism 192 to shift gears.

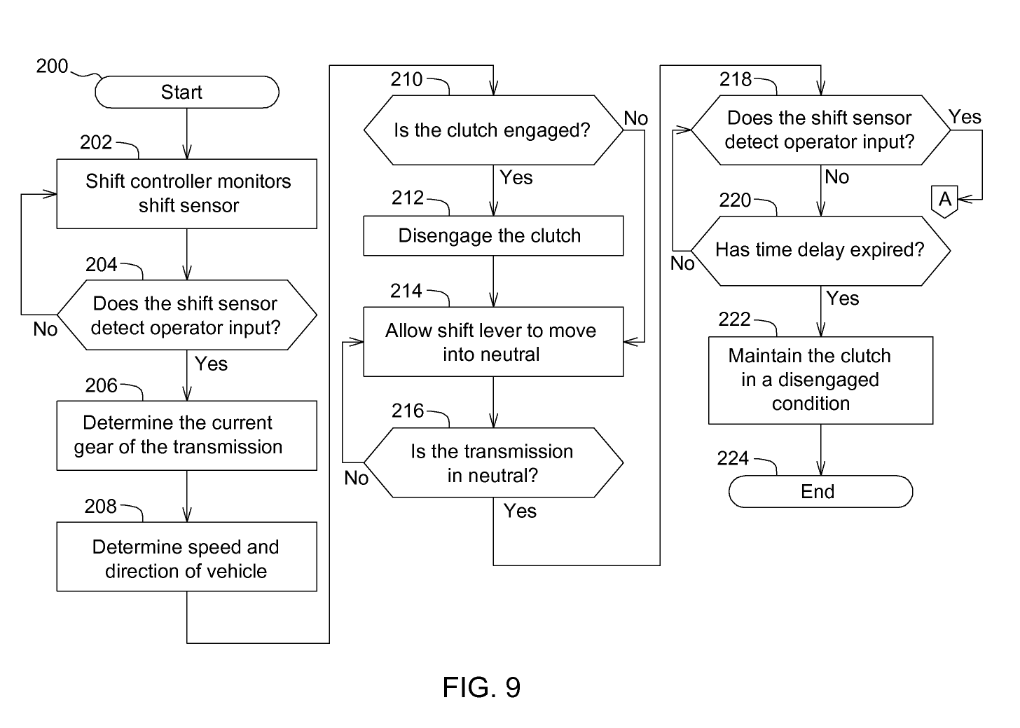

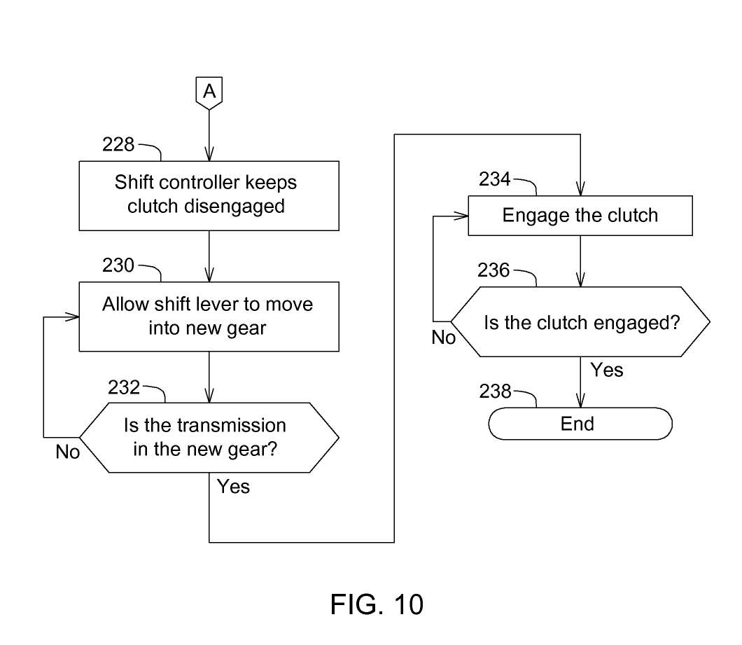

FIGS. 9 and 10 illustrate a flow chart of a method of shifting gears in a transmission 120, according to the one embodiment, which may be implemented in the embodiment depicted in FIG. 6, in FIG. 7, or both. At step 200, the method starts.

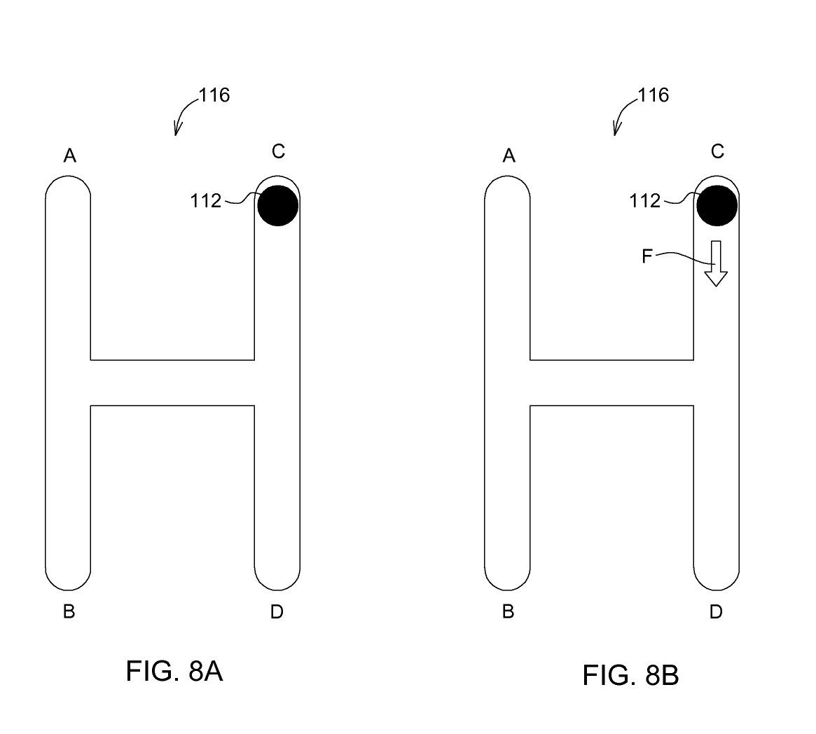

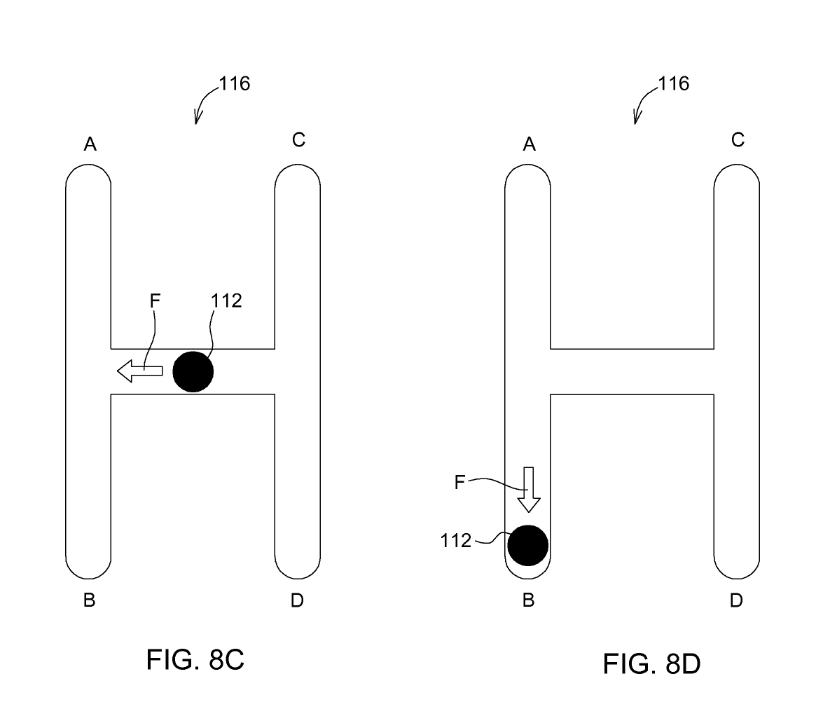

At step 202, the shift controller 170 the shift lever 112 may be positioned in a gear, or range C, as shown in FIG. 8A. The transmission 120 would then be in the corresponding gear, or range C, and the work machine 100 would be traveling at an applicable speed for gear, or range C.

At step 204, an operator input F may be applied to the shift lever 112 to move the shift lever 112 out of gear, or range C, as shown in FIG. 8B. When the shift lever 112 receives an operator input F, the shift sensor 180 detects the operator input F. The shift controller 170 determines the shift lever 112 has received an operator input F based at least partially upon communication with the shift sensor 180.

At step 206, the shift controller 170 may determine which gear the transmission 120 is in based at least partially upon communication with the gear sensor 182, the position sensor 184, or both. In some embodiments, step 206 is omitted.

At step 208, the shift controller 170 may determine the speed and direction of the work machine 100 based at least partially upon communication with the speed sensor 186, the gear sensor 182, or both. In some embodiments, step 208 is omitted.

At step 210, the shift controller 170 determines whether the clutch 160 is engaged or disengaged based at least partially upon communication with one or more of the engagement mechanism 162, the engagement control 164, or the engagement sensor 188.

At step 212, if the clutch 160 is engaged, the shift controller 170 communicates with the engagement control 164, or directly with the engagement mechanism 162, to disengage the clutch 160. The engagement mechanism 162 disengages the clutch 160 based at least partially upon the direction from the engagement control 164, the shift controller 170, or both. The shift controller 170 may again determine whether the clutch 160 is disengaged.

At step 214, when the clutch 160 is disengaged, or if the clutch 160 was already disengaged, the shift lever 112 may be moved out of gear, or range C, and into neutral, as shown in FIG. 8C.

At step 216, the position sensor 184, the shift sensor 180, or both may detect that the shift lever 112 is in the neutral position. The gear sensor 182, the position sensor 184, or both may detect the transmission 120 is in neutral. The shift controller 170 determines that the shift lever 112 and the transmission 120 are in the neutral position based at least partially upon communication with the position sensor 184, the gear sensor 182, the shift sensor 180, or any combination of the three.

At step 218, the operator input F may now be removed from the shift lever 112, or the shift lever 112 may continue to move through the neutral position into another gear or range due to the operator input F. If the operator input F is removed from the shift lever 112, the shift lever 112 and the transmission 120 remain in neutral.

At step 220, the shift controller 170 can monitor the length of time the shift lever 112 is in the neutral position, and after a specific or certain length of time, or time delay, the shift controller 170 can determine to maintain the clutch 160 is a disengaged condition. The shift controller 170 may determine to maintain the clutch 160 is a disengaged condition when the transmission remains in a neutral condition for a set length of time and the shift sensor 180 detects that the operator input has been removed from the shift lever 112.

At step 222, the shift controller 170 maintains the clutch 160 is a disengaged condition.

At step 224, the shift from one gear, or range C, into neutral has occurred, according to one embodiment. In other embodiments, one or more of these steps or operations may be omitted, repeated, or re-ordered and still achieve the desired results.

At step 228, if the shift lever 112 continues to move through the neutral position due to the operator input F, the shift controller 170 maintains the clutch 160 in the disengaged position based at least partially upon communication with one or more of the shift sensor 180 detecting the operator input F, the position sensor 184 detecting the position of the shift lever 112, or the gear sensor 182 detecting the gear the transmission 120 is in.

At step 230, with the clutch 160 still disengaged, the shift lever 112 may be moved into another gear, or range B, as shown in FIG. 8D.

At step 232, the shift controller 170 determines that the transmission 120 has also moved into another gear, or range B, based at least partially upon communication with the gear sensor 182 detecting which gear the transmission 120 is in.

At step 234, the shift controller 170 then communicates with the engagement control 164, or the engagement mechanism 162, to engage the clutch 160. The engagement mechanism 162 engages the clutch 160 based at least upon the communication from the shift controller 170 or the engagement control 164.

At step 236, the shift controller 170 may determine the clutch 160 is engaged based at least upon communication with one or more of the engagement mechanism 162, engagement control 164, or engagement sensor 188.

At step 238, the shift from one gear to another, or from range C to range B, has occurred, according to one embodiment. In other embodiments, one or more of these steps or operations may be omitted, repeated, or re-ordered and still achieve the desired results.

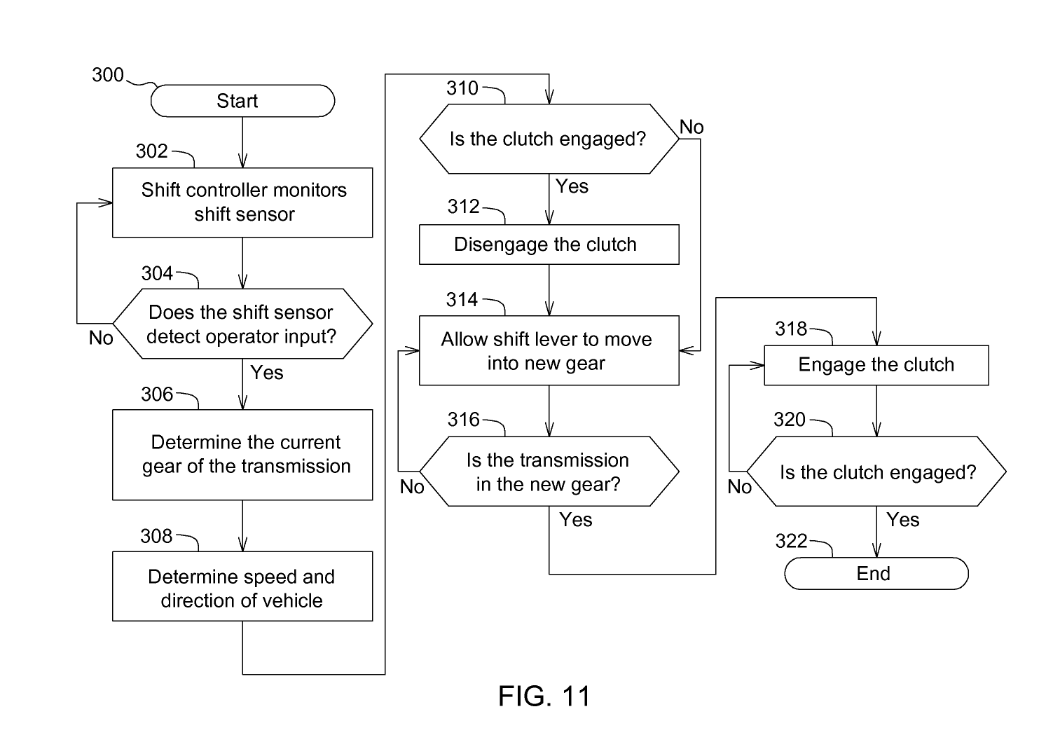

FIG. 11 illustrates a flow chart of a method of shifting gears in a transmission 120, according to the one embodiment, which may be implemented in the embodiment depicted in FIG. 6, in FIG. 7, or both. At step 300, the method starts.

At step 302, the shift lever 112 may be positioned in neutral, as shown in FIG. 8C. The transmission 120 would then be in the corresponding neutral condition.

At step 304, an operator input F may be applied to the shift lever 112 to move the shift lever 112 out of neutral, as shown in FIG. 8C. When the shift lever 112 receives an operator input F, the shift sensor 180 detects the operator input F. The shift controller 170 determines the shift lever 112 has received an operator input F based at least partially upon communication with the shift sensor 180.

At step 306, the shift controller 170 may also determine which gear the transmission 120 is in based at least partially upon communication with the gear sensor 182, the position sensor 184, or both. In some embodiments, step 306 is omitted.

At step 308, the shift controller 170 may also determine the speed and direction of the work machine 100 based at least partially upon communication with the speed sensor 186, the gear sensor 182, or both. In some embodiments, step 308 is omitted.

At step 310, the shift controller 170 determines whether the clutch 160 is engaged or disengaged based at least partially upon communication with one or more the engagement mechanism 162, the engagement control 164, or the engagement sensor 188.

At step 312, if the clutch 160 is engaged, the shift controller 170 communicates with the engagement control 164, or directly with the engagement mechanism 162, to disengage the clutch 160. The engagement mechanism 162 disengages the clutch 160 based at least partially upon the direction from the engagement control 164 or the shift controller 170. The shift controller 170 may again determine whether the clutch 160 is disengaged.

At step 314, when the clutch 160 is disengaged, or if the clutch 160 was already disengaged, the shift lever 112 may move into another gear, or range B as shown in FIG. 8D, due to the operator input F.

At step 316, the shift controller 170 determines that the transmission 120 has also moved into another gear, or range B, based at least partially upon communication with the gear sensor 182 detecting which gear the transmission 120 is in, the position sensor 184 detecting the position of the shift lever 112 or mechanical linkage 122, or both.

At step 318, the shift controller 170 then communicates with the engagement control 164, or the engagement mechanism 162, to engage the clutch 160. The engagement mechanism 162 engages the clutch 160 based upon the communication from the shift controller 170, the engagement control 164, or both.

At step 320, the shift controller 170 may determine the clutch 160 is engaged based at least upon communication with one or more of the engagement mechanism 162, the engagement control 164, or the engagement sensor 188.

At step 322, the shift from neutral into a gear, or range B, has occurred, according to one embodiment. In other embodiments, one or more of these steps or operations may be omitted, repeated, or re-ordered and still achieve the desired results.

Without in any way limiting the scope, interpretation, or application of the claims appearing below, a technical effect of one or more of the example embodiments disclosed herein is an automated clutch which reduces or removes the need for the machine operator to manually disengage the clutch before shifting gears or ranges in a transmission and manually engaging the clutch after shifting gears or ranges. Another technical effect of one or more of the example embodiments disclosed herein is an automated clutch which automatically engages and disengages a clutch without the use of a clutch pedal. Another technical effect of one or more of the example embodiments disclosed herein is faster shift times. Another technical effect of one or more of the example embodiments disclosed herein is reduced or minimal effort to shift gears in a transmission. Another technical effect of one or more of the example embodiments disclosed herein is a reliable apparatus and method for automated clutch engagement and disengagement when shifting gears in a transmission.

The terminology used herein is for the purpose of describing particular implementations and is not intended to be limiting of the disclosure. As used herein, the singular forms “a”, “an” and “the” are intended to include the plural forms as well, unless the context clearly indicates otherwise. It will be further understood that the any use of the terms “has,” “have,” “having,” “include,” “includes,” “including,” “comprise,” “comprises,” “comprising,” or the like, in this specification, identifies the presence of stated features, integers, steps, operations, elements, and/or components, but does not preclude the presence or addition of one or more other features, integers, steps, operations, elements, components, and/or groups thereof.

The references “A” and “B” used with reference numerals (e.g., 116A, 116B) herein are merely for clarification when describing multiple implementations of an apparatus.

One or more of the steps or operations in any of the methods, processes, or systems discussed herein may be omitted, repeated, or re-ordered and are within the scope of the present disclosure.

While the above describes example embodiments of the present disclosure, these descriptions should not be viewed in a restrictive or limiting sense. Rather, there are several variations and modifications which may be made without departing from the scope of the appended claims.

What is claimed is:

1. A transmission shifting apparatus comprising:
a transmission having a plurality of gears;
a clutch positioned between a power source and the transmission, the clutch coupling the power source to the transmission in an engaged position and uncoupling the power source from the transmission in a disengaged position;
a shift lever operably connected to the transmission, movement of the shift lever causing the transmission to shift gears;
a shift sensor operably connected to the shift lever, the shift sensor detecting when an operator input is applied to the shift lever in a manner to generate a gear shift;
a shift controller which disengages the clutch when the shift sensor detects the operator input, and engages the clutch when the shift controller determines the gear shift is complete.

2. The transmission shifting apparatus of claim 1, wherein the shift sensor detects the magnitude and direction of the operator input.

3. The transmission shifting apparatus of claim 1, wherein the shift controller determines whether the operator input has been removed from the shift lever before engaging the clutch.

4. The transmission shifting apparatus of claim 1, wherein the shift controller determines whether the transmission is in a gear before engaging the clutch.

5. The transmission shifting apparatus of claim 1, wherein the shift controller determines the shift is not complete when the transmission has been in a neutral condition for a set length of time and the shift sensor detects that the operator input was removed from the shift lever.

6. The transmission shifting apparatus of claim 1, further comprising:
a position sensor which detects the position of the shift lever including whether the shift lever is in a neutral position, the position sensor in communication with the shift controller.

7. The transmission shifting apparatus of claim 1, further comprising:
a gear sensor which detects which gear the transmission is in including whether the transmission is in neutral condition, the gear sensor in communication with the shift controller.

8. The transmission shifting apparatus of claim 1, further comprising:
a speed sensor which detects the speed and direction of an output of the transmission, the speed sensor in communication with the shift controller.

9. The transmission shifting apparatus of claim 1, further comprising:
an engagement sensor which detects whether the clutch is engaged or disengaged, the engagement sensor in communication with the shift controller.

10. The transmission shifting apparatus of claim 1, further comprising:
an engagement mechanism which selectively engages and disengages the clutch based upon direction from the shift controller.

11. The transmission shifting apparatus of claim 1, further comprising:
a shift mechanism which selectively shifts gears in the transmission based upon direction from the shift controller.

12. A method of shifting a transmission in a vehicle comprising:
automatically disengaging a clutch when a shift sensor detects an operator input being applied to a shift lever operably connected to the transmission, the disengaged clutch uncoupling a power source from the transmission;
determining whether the shift is complete;
automatically engaging the clutch upon determining that the shift is complete, the engaged clutch coupling the power source to the transmission.

13. The method of claim 12, further comprising:
determining whether the operator input has been removed from the shift lever before engaging the clutch.

14. The method of claim 12, wherein the step of engaging the clutch further comprises determining whether the transmission is in a gear before engaging the clutch.

15. The method of claim 12, wherein the shift controller determines that the shift is not complete when the transmission has been in a neutral condition for set length of time and the shift sensor detects that the operator input was removed from the shift lever.

16. The method of claim 12, wherein the step of disengaging the clutch further comprises determining whether the clutch is engaged before directing an engagement mechanism to disengage the clutch.

17. The method of claim 12, wherein the step of engaging the clutch further comprises shifting the transmission out of neutral and into a first gear before engaging the clutch.

18. The method of claim 12, wherein the step of engaging the clutch further comprises shifting the transmission out of a first gear and into a second gear before engaging the clutch.

19. The method of claim 12, wherein the step of engaging the clutch further comprises shifting the transmission out of a first gear, into neutral, and back into the first gear before engaging the clutch.

20. The method of claim 12, wherein the shift sensor detects whether the operator input is a shifting input before disengaging the clutch.
